(19) United States
(12) Patent Application Publication
(10) Pub. No.: US 2025/0202154 A1
(43) Pub. Date: Jun. 19, 2025

(54) POWER HARNESS

(71) Applicant: TE Connectivity Solutions GmbH, Schaffhausen (CH)

(72) Inventors: Dinesh Loku Hemnani, Greensboro, NC (US); Kevin John Peterson, Kernersville, NC (US)

(21) Appl. No.: 18/540,569

(22) Filed: Dec. 14, 2023

(51) Int. Cl. H01R 13/502; B60R 16/033; H01R 13/447; H01R 13/52; H01R 13/621; H01R 13/6581; H01R 13/6592

(52) U.S. Cl. CPC H01R 13/502; B60R 16/033; H01R 13/447; H01R 13/5221; H01R 13/6215; H01R 13/6581; H01R 13/6592

(57) ABSTRACT

A power harness includes a housing configured to be mated with a mating harness connector. The power harness includes a power conductor extending from the housing and a power contact received in the housing having a terminating end terminated to the power conductor and a mating end for mating with a mating power contact of the mating harness connector. The power contact includes a base plate and side walls extending from the base plate on opposite sides of a gap with outer edges forming mating interfaces for mating engagement with the mating power contact. The power harness includes a threaded connector passing through the housing and located in the gap between the side walls for threadably coupling to a mating threaded connector of the mating harness connector.

### BACKGROUND OF THE INVENTION

The subject matter herein relates generally to power connectors.

Power connectors are used to electrically connect various electrical components, such as to deliver power from one component to another component. For example, in an electric vehicle, power connectors may be used to electrically connect the battery of the vehicle with another component, such as an electric motor of the vehicle. Some known systems use power cables or busbars for high voltage power transmission. However, connection between the power cables may be difficult. For example, when used in electric vehicles, the connection is susceptible to vibration and deterioration from the environment, such as moisture or debris. Additionally, the connectors include many parts, making assembly time consuming with potential to misplace or lose components during assembly or mating.

A need remains for a robust and reliable power connector system, such as for electric vehicles.

### BRIEF DESCRIPTION OF THE INVENTION

In one embodiment, a power harness is provided and includes a housing having a chamber extending between a terminating end and a mating end configured to be mated with a mating harness connector of the power harness. The housing includes a hub at the mating end with a bore passing through the housing. The power harness includes a power conductor extending from the chamber at the terminating end. The power harness includes a power contact received in the chamber. The power contact has a terminating end terminated to the power conductor and a mating end aligned with the bore at the mating end of the housing. The power contact includes a base plate at the mating end and side walls extending from the base plate on opposite sides of a gap. The side walls have outer edges opposite the base plate. The outer edges form mating interfaces for mating engagement with a mating power contact of the mating harness connector. The base plate has an opening aligned with the gap. The power harness includes a threaded connector received in the hub and passing through the bore. The threaded connector aligned with the opening and located in the gap between the side walls. The threaded connector configured to be threadably coupled to a mating threaded connector of the mating harness connector.

In another embodiment, a power harness is provided and includes a housing having a chamber extending between a cable end and a mating end configured to be mated with a mating harness connector of the power harness. The housing includes a housing insert and an outer shell holding the housing insert. The housing insert includes a hub at the mating end with a bore passing through the hub. The housing insert includes a contact channel. The power harness includes a housing shield in the chamber. The housing shield has a shield cable end and a shield mating end configured to be mated to a mating shield of the mating harness connector. The power harness includes a housing seal at the mating end of the housing. The housing seal configured to be sealed to the mating harness connector. The power harness includes a power cable extending into the chamber at the cable end. The power cable includes a power conductor, an insulator surrounding the power conductor, and a cable shield surrounding the insulator. The cable shield is electrically connected to the shield cable end of the housing shield. The power cable includes a cable seal configured to be sealed between the power cable and the housing to seal the terminating end of the housing. The power harness includes a power contact received in the chamber. The power contact has a terminating end terminated to the power conductor of the power cable and a mating end aligned with the bore at the mating end of the housing. The power contact includes a base plate at the mating end and side walls extending from the base plate on opposite sides of a gap. The side walls have outer edges opposite the base plate. The outer edges form mating interfaces for mating engagement with a mating power contact of the mating harness connector. The base plate has an opening aligned with the gap. The power harness includes a threaded bolt received in the hub and passing through the bore. The threaded bolt aligned with the opening and located in the gap between the side walls. The threaded bolt includes an insulating cover covering a head and an insulating cap at a distal end of a threaded shaft. The threaded shaft configured to be threadably coupled to a mating threaded connector of the mating harness connector. The threaded bolt includes a bolt seal sealed between the threaded bolt and the housing.

In a further embodiment, a power harness is provided and includes a first harness connector including a first housing having a first hub with a first bore passing through the first housing. The first harness connector includes a first power conductor. The first harness connector includes a first seal sealed to the first housing. The first harness connector includes a threaded bolt received in the first hub and passing through the first bore. The threaded bolt includes an insulating cover covering a head and an insulating cap at a distal end of a threaded shaft. The first harness connector includes a bolt seal sealed between the threaded bolt and the first housing. The first harness connector includes a first power contact received in the first hub. The first power contact has a terminating end terminated to the first power conductor and a mating end aligned with the first bore. The first power contact includes a first base plate and first side walls extending from the first base plate on opposite sides of a first gap. The first gap receiving the threaded bolt. The first side walls have outer edges opposite the first base plate. The power harness includes a second harness connector coupled to the first harness connector. The second harness connector includes a second housing having a second hub with a second bore passing through the second housing. The second harness connector includes a second power conductor. The second harness connector includes a second cable seal sealed to the second housing. The second harness connector includes a socket insert received in the second hub and passing through the second bore. The socket insert includes a threaded bore threadably coupled to the threaded bolt of the first harness connector. The socket insert includes an insulating cap at a distal end of socket insert. The second harness connector includes a second power contact has a terminating end terminated to the second power conductor and a mating end aligned with the second bore. The second power contact includes a second base plate and second side walls extending from the second base plate on opposite sides of a second gap. The second gap receiving the socket insert. The second side walls have outer edges opposite the second base plate configured to interface with the outer edges of the first side walls to electrically connect the second power contact to the first power contact. The power harness includes a mating seal sealed between the first housing and the second housing at a mating interface between the first and second harness connectors.

### BRIEF DESCRIPTION OF THE DRAWINGS

FIG. 1 is a top perspective view of a power system having a power harness in accordance with an exemplary embodiment.

FIG. 2 is an exploded view of the first harness connector in accordance with an exemplary embodiment.

FIG. 3 is an exploded, partial sectional view of the first harness connector in accordance with an exemplary embodiment.

FIG. 4 is a perspective view of the power contact in accordance with an exemplary embodiment.

FIG. 5 is a bottom view of the first harness connector in accordance with an exemplary embodiment.

FIG. 6 is a top perspective view of the second harness connector in accordance with an exemplary embodiment.

FIG. 7 is a perspective view of the power contact in accordance with an exemplary embodiment.

FIG. 8 is a cross sectional view of the power system showing the first harness connector mated with the second harness connector in accordance with an exemplary embodiment.

### DETAILED DESCRIPTION OF THE INVENTION

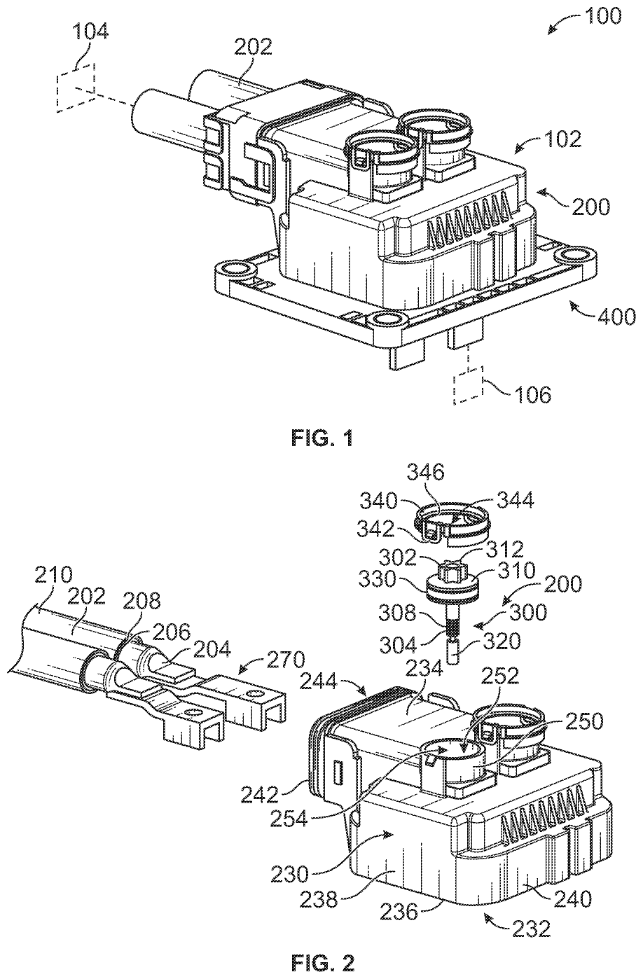

FIG. 1 is a top perspective view of a power system 100 having a power harness 102 in accordance with an exemplary embodiment. The power harness 102 includes power connectors used to electrically connect a first component 104 and a second component 106. For example, the power harness 102 includes a first harness connector 200 and a second harness connector 400. The first harness connector 200 is a cable connector provided at an end of one or more power cables 202 (for example, two power cables 202 in the illustrated embodiment). The second harness connector 400 may additionally or alternatively be provided at an end of a power cable (not shown). In the illustrated embodiment, the second harness connector 400 is a header connector mounted directly to the electrical component 106. The first harness connector 200 is a plug connector configured to be plugged onto the second harness connector 400 (for example, header connector) to electrically connect the components 104, 106. The harness connectors 200, 400 provide a separable interface in a power transmission line between the first and second components 104, 106.

In various embodiments, the power system 100 may be part of a vehicle, such as an electric vehicle. The first component 104 may be a battery of the vehicle and the second component 106 may be a powered device of the vehicle, such as an inverter or motor of the vehicle or a vehicle subsystem, such as a charging inlet, a heater, a compressor, or another vehicle subsystem. The power system 100 may be used in other applications other than electric vehicles in alternative embodiments.

In an exemplary embodiment, the first and second harness connectors 200, 400 are mechanically connected using threaded components, such as a threaded bolt received in a threaded insert, connect the first and second harness connectors 200, 400. In an exemplary embodiment, the harness connectors 200, 400 are compact or low profile, such as occupying not much more space (for example, height and/or width and/or length) than the corresponding power cable(s) 202. In an exemplary embodiment, the harness connectors 200, 400 are sealed connectors forming a sealed interface therebetween. The first harness connector 200 is sealed to the power cable 202. The second harness connector 400 is sealed to the component 106. The harness connectors 200, 400 are sealed to each other using an environmental seal at the mating interface. The threaded fasteners may additionally be sealed within the harness connectors 200, 400. In an exemplary embodiment, the harness connectors 200, 400 are touch safe, wherein any and all live conductive elements are insulated to prevent short circuiting, sparking, arcing or injury from touching the live element. The harness connectors 200, 400 are touch safe both in the mated conditions and the unmated condition. In an exemplary embodiment, the harness connectors 200, 400 are vibration resistant to maintain a reliable electrical connection along the power transmission line. In an exemplary embodiment, the harness connectors 200, 400 may be mated at various orientations relative to each other. For example, the power cables 202 may extend away from the connection at different angles, such as 180°, 90° or at other angles. While a single interface is illustrated in FIGS. 1 and 2, the harness connectors 200, 400 may have multiple interfaces.

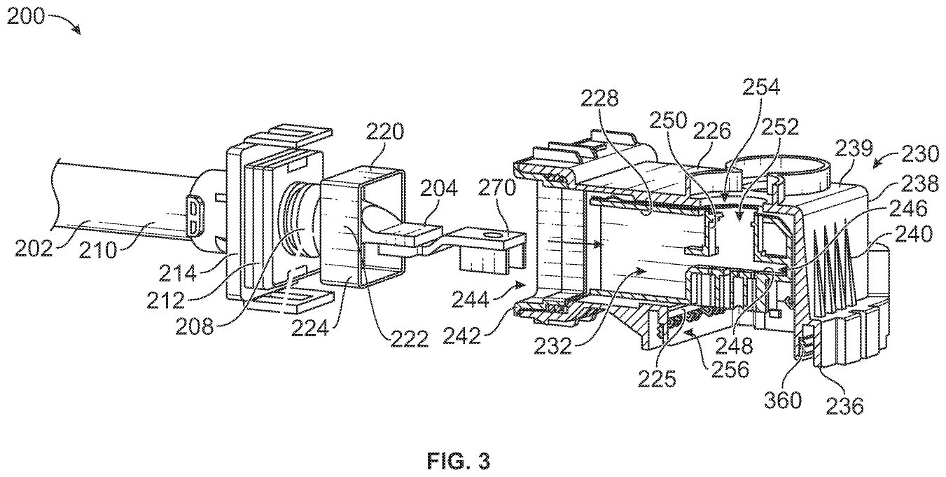

FIG. 2 is an exploded view of the first harness connector 200 in accordance with an exemplary embodiment. FIG. 3 is an exploded, partial sectional view of the first harness connector 200 in accordance with an exemplary embodiment. The first harness connector 200 includes the power cable 202, a housing 230, a power contact 270, and a threaded bolt 300. The housing 230 receives the power cable 202, the power contact 270, and the threaded bolt 300. The housing 230 is configured to be mated with the second harness connector 400 (shown in FIG. 1). The threaded bolt 300 is used to mechanically connect the first harness connector 200 to the second harness connector 400. The power contact 270 is used to electrically connect the power cable 202 to the second harness connector 400.

In an exemplary embodiment, the power cable 202 is a shielded and jacketed cable. The power cable 202 may be a solid core cable or may be a stranded or braided cable. The power cable 202 includes a power conductor 204, an insulator 206 surrounding the conductor 204, a cable shield 208 surrounding the insulator 206 and a cable jacket 210 surrounding the insulator 206. The cable jacket 210 is made from a dielectric or other insulating material to make the power cable 202 touch safe. The power conductor 204 may be manufactured from aluminum, copper or an alloy thereof. The power conductor 204 is exposed at the terminating end of the power cable 202 for connection to the power contact 270. In the illustrated embodiment, the power cable 202 is a round power cable. However, in alternative embodiments, the power cable 202 may be generally rectangular in cross-section, such as having generally planar top and bottom surfaces. In alternative embodiments, the power conductor 204 may be a busbar or metal plate rather than a power cable.

In an exemplary embodiment, a cable seal 212 is provided surrounding the power cable 202. The cable seal 212 may be sealed to the cable jacket 210. The cable seal 212 is configured to be sealed against the housing 230. The cable seal 212 may be a rubber material in various embodiments. Optionally, multiple cable seals 212 may be used to seal to the various components.

In an exemplary embodiment, a cable seal retainer 214 is provided at the end of the power cable 202 and is configured to be coupled to the housing 230. The cable seal retainer 214 may be secured to the housing 230 by a latch, clip, fastener or other securing element. The cable seal retainer 214 may provide strain relief for the power cable 202. The cable seal retainer 214 may hold or support the cable seal 212. The cable seal retainer 214 covers the opening in the housing 230 from impingement of moisture, such as from high pressure spray.

In an exemplary embodiment, the first harness connector 200 includes a connector shield 220. The connector shield 220 is configured to be connected to the cable shield 208. In various embodiments, the connector shield 220 may be crimped to the cable shield 208. The connector shield 220 includes a mating end 222 at the front configured to be mated with a housing shield 225 of the housing 230. In an exemplary embodiment, the connector shield 220 includes walls 224 at the mating end 222 configured to be connected to the housing shield 225. In the illustrated embodiment, the four walls 224 are provided in a rectangular or square shape. Greater or fewer walls 224 may be provided in alternative embodiments and the mating end 222 may have a different shape in alternative embodiments. The connector shield 220 is used to electrically connect the cable shield 208 to the housing shield 225. In alternative embodiments, the cable shield 208 may be directly connected to the housing shield 225 rather than using the connector shield 220.

The housing 230 is manufactured from a dielectric material, such as a plastic material. Optionally, the housing 230 may be an injection molded part. In various embodiments, the housing 230 is a multi-piece housing. For example, the housing 230 may include an outer shell 226 and a housing insert 228 received in the outer shell 226. The housing shield 225 is located in the housing 230, such as between the outer shell 226 and the housing insert 228. The housing shield 225 may be held by the outer shell 226 and/or the housing insert 228. The various components of the housing 230 described herein may be part of the outer shell 226 and/or the housing insert 228. In other various embodiments, the housing 230 may be clamshell type housing having an upper housing and a lower housing.

The housing 230 includes walls forming a chamber 232 that receives the power cable 202, the power contact 270, and the threaded bolt 300. The housing shield 225 provides shielding within the chamber 232. In an exemplary embodiment, the housing 230 includes a top 234 and a bottom 236. The housing 230 includes sides 238 extending between a front 240 and a rear 242. The housing 230 includes a cable opening 244 at the rear 242 providing access to the chamber 232. The power cable 202 is received in the cable opening 244. In various embodiments, the cable opening 244 may be oriented generally horizontally. The cable seal retainer 214 may be plugged into the cable opening 244 and coupled to the housing 230 at the rear 242. The cable seal 212 may be sealed to the interior surface of the housing 230 (for example, to the housing insert 228) at the cable opening 244.

In an exemplary embodiment, the housing 230 includes a contact channel 246 in the chamber 232 that receives the power contact 270. The contact channel 246 is aligned with the cable opening 244 to receive the power contact 270 with the power cable 202 from the cable opening 244. The contact channel 246 receives the power contact 270 in a rear-to-front loading direction as the power contact 270 is loaded into the housing 230 from the rear 242. In the illustrated embodiment, the contact channel 246 is located at the front 240. The housing 230 includes walls 248 defining the contact channel 246. The walls 248 may form slots defining the contact channel 246, such as one or more horizontal slot and/or one or more vertical slots.

In an exemplary embodiment, the housing 230 includes a hub 250 having a bore 252 passing through the hub 250. The bore 252 is open to and defines a portion of the chamber 232. In various embodiments, the hub 250 is generally cylindrical. However, the hub 250 may have other shapes in alternative embodiments. The bore 252 passes through the housing 230, such as along a vertical axis between the top 234 and the bottom 236. In an exemplary embodiment, the power contact 270 is positioned in the housing 230 aligned with the bore 252, such as along the vertical axis, to receive the threaded bolt 300. The bore 252 includes an upper opening 254 and a lower opening 256. The threaded bolt 300 is received in the hub 250 and passes through the bore 252. For example, the threaded bolt 300 may pass through the upper opening 254 and/or the lower opening 256. In an exemplary embodiment, the contact channel 246 is aligned with the hub 250. The power contact 270 is received in the hub 250 when loaded into the contact channel 246.

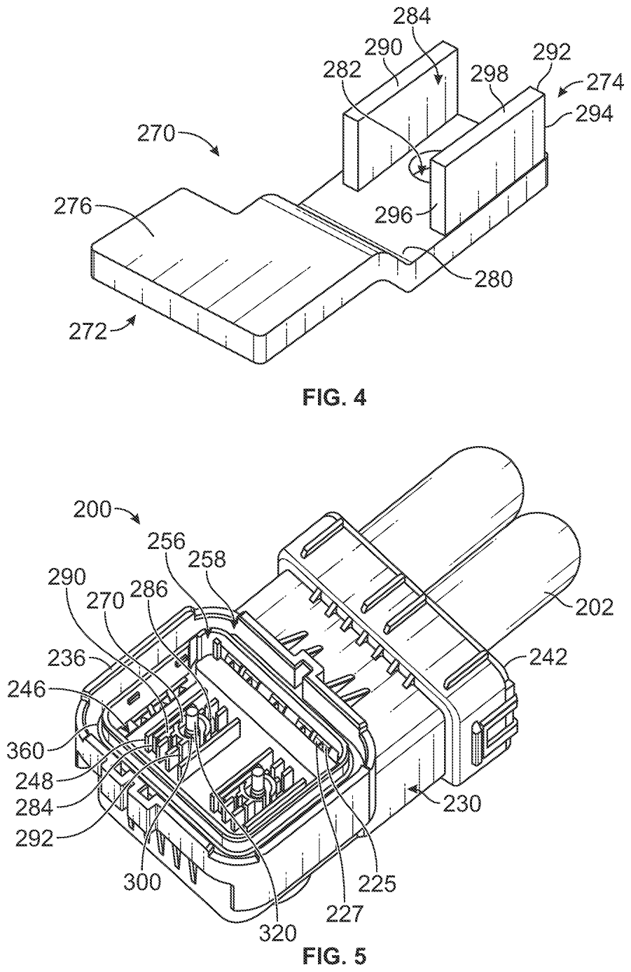

With additional reference to FIG. 4, which is a perspective view of the power contact 270 in accordance with an exemplary embodiment, the power contact 270 is a metal conductor, such as an aluminum or copper conductor. The power contact 270 may be an extruded metal contact in various embodiments. Alternatively, the power contact 270 may be hot forged or stamped and formed. The power contact 270 may be plated or coated in various embodiments. The power contact 270 may include a textured or knurled surface at the mating interface to improve electrical contact.

The power contact 270 extends between a terminating end 272 and a mating end 274. The terminating end 272 is configured to be terminated to the power conductor 204 of the power cable 202. The mating end 274 is configured to be mated with the corresponding power contact of the second harness connector 400. The power contact 270 includes a weld pad 276 at the terminating end 272. The power conductor 204 is welded to the weld pad 276 at the terminating end 272. Other types of terminations may be used in alternative embodiments, such as a crimp barrel being crimped to the power conductor 204. The power contact 270 may be a multi-piece component, such as having the terminating end 272 discrete from and coupled to the mating end 274. For example, the components may be press-fit or welded together.

The power contact 270 includes a base plate 280 at the mating end 274. The base plate 280 may be planar. In various embodiments, the base plate 280 may be oriented horizontally. The base plate 280 includes an opening 282 therethrough, which may be approximately centered between the front and the rear and/or between the opposite sides of the base plate 280. The base plate 280 may define the weld pad 276, such as having the cable welded to the bottom of the base plate 280, such as being resistance welded to the base plate 280. The opening 282 may be drilled through the base plate 280 and the conductor of the cable.

In an exemplary embodiment, the power contact 270 includes side walls 290, 292 extending from the base plate 280. The side walls 290, 292 are located on opposite sides of a gap 284. The gap 284 is aligned with the opening 282, such as to receive the threaded bolt 300. Each side wall 290, 292 extends between a front 294 and a rear 296. The gap 284 may be open at the front 294 and/or the rear 296. Each side wall 290, 292 extends to an outer edge 298 opposite the base plate 280. The gap 284 is open between the outer edges 298. The outer edge 298 forms a mating interface for mating engagement with the power contact of the second harness connector 400. The side walls 290, 292 have lengths (between the front 294 and the rear 296) and widths (side-to-side), which define a surface area at the mating interface. The surface area may control the amount of power or current carrying capacity for the power contact. The surface area may be increased by increasing the lengths or widths of the side walls 290, 292.

In an exemplary embodiment, the side walls 290, 292 extend parallel to each other on opposite sides of the gap 284. The side walls 290, 292 may be oriented perpendicular to the base plate 280. In various embodiments, the base plate 280 and the side walls 290, 292 are U-shaped surrounding the gap 284. Optionally, the base plate 280 may be orientated horizontally and the side walls 290, 292 may be oriented vertically.

The threaded bolt 300 is a threaded connector configured to be threadably coupled to a corresponding threaded connector of the second harness connector 400. The threaded bolt 300 includes a head 302 and a threaded shaft 304 extending from the head 302. The threaded shaft 304 includes threads at a distal end 308 of the threaded shaft 304. In an exemplary embodiment, the threaded bolt 300 is touch safe. For example, the threaded bolt 300 includes an insulating cover 310 on the head 302 and an insulating cap 320 extending from the distal end 308 of the threaded shaft 304.

The insulating cover 310 may be overmolded onto the head 302. Alternatively, the insulating cover 310 may be pre-formed and snap-fit, press-fit, adhered, or otherwise secured to the head 302. The insulating cover 310 covers the head 302 to prevent touching of the metal or conductive portion of the threaded bolt 300. The insulating cover 310 includes drive features 312 for driving or rotating the threaded bolt 300. For example, the drive features 312 may be flat surfaces at the top of the insulating cover 310 that allow a socket wrench or other tool to rotate the threaded bolt 300 clockwise or counterclockwise for tightening or untightening the threaded bolt 300 during assembly with the second harness connector 400. Other types of drive features may be used in alternative embodiments, such as one or more slots to receive a screwdriver or other type of tool for tightening and untightening the threaded bolt 300.

The insulating cap 320 may be overmolded on to the threaded shaft 304. Alternatively, the insulating cap 320 may be pre-formed and snap-fit, press-fit, adhered, or otherwise secured to the distal end 308 of the threaded shaft 304. The insulating cap 320 covers the threaded shaft 304 to prevent touching of the metal or conductive portion of the threaded bolt 300.

In an exemplary embodiment, the first harness connector 200 includes a bolt seal 330 to seal between the threaded bolt 300 and the housing 230. In the illustrated embodiment, the bolt seal 330 is coupled to the insulating cover 310 at the head 302 of the threaded bolt 300. The outer surface of the bolt seal 330 is configured to be sealed to the housing 230, such as to the hub 250 when the threaded bolt 300 is received in the hub 250. For example, the bolt seal 330 may have a diameter equal to the diameter of the hub 250 at the upper opening 254.

In an exemplary embodiment, the first harness connector 200 includes a bolt retainer 340 to retain the threaded bolt 300 in the housing 230. The bolt retainer 340 may be coupled to the housing 230 outward of the threaded bolt 300, such as above the head 302 and the insulating cover 310. The bolt retainer 340 may be coupled to the hub 250. The bolt retainer 340 includes latches 342 configured to be latchably coupled to the housing 230 to secure the bolt retainer 340 to the housing 230. In an exemplary embodiment, the bolt retainer 340 includes an opening 344 to provide access to the threaded bolt 300, such as for engaging the drive features 312 to rotate the threaded bolt 300. However, in alternative embodiments, the bolt retainer 340 may be closed to prevent access to the threaded bolt 300. In an exemplary embodiment, the bolt retainer 340 includes one or more retaining features 346 to retain the threaded bolt 300 in the housing 230. In the illustrated embodiment, the retaining feature 346 is a lip or rim extending into the opening 344. The lip is configured to be seated above the head 302 and the insulating cover 310 to prevent removal of the threaded bolt 300 through the opening 344. Other types of retaining features may be used in alternative embodiments.

In an exemplary embodiment, the first harness connector 200 includes a mating seal 360 coupled to the housing 230 at a mating end 260 of the housing 230. In the illustrated embodiment, the mating end 260 is provided at the bottom 236. The mating end 260 is located at the lower opening 256 of the hub 250. The mating end 260 is configured to be mated with the second harness connector 400. In an exemplary embodiment, the housing 230 includes a groove 258 at the bottom 236 surrounding the lower opening 256. The mating seal 360 is located in the groove 258. Optionally, the groove 258 may receive a portion of the housing of the second harness connector 400 to seal to the mating seal 360 in the groove 258. In alternative embodiments, the mating seal 360 may be located at the bottom and face downward to interface with the housing of the second harness connector 400.

FIG. 5 is a bottom view of the first harness connector 200 in accordance with an exemplary embodiment. In the illustrated embodiment, the first harness connector 200 includes a pair of the power contacts 270 and corresponding power cables 202 held within the same housing 230. Greater or fewer power contacts 270 and power cables 202 may be provided in alternative embodiments. The power cables 202 extend from the rear 242. The power contacts 270 and the threaded bolts 300 are provided at the mating end 260. The power contacts 270 and the threaded bolts 300 are exposed at the bottom 236 for mating with the second harness connector 400 (FIG. 1). The mating seal 360 is located at the bottom 236, such as in the groove 258, to provide a sealed mating interface with the second harness connector 400.

In an exemplary embodiment, the first harness connector 200 is touch safe. For example, the threaded bolts 300 include insulating caps 320 at the distal ends thereof. The insulating caps 320 extend from the housing 230, such as below the bottom of the housing 230 to cover the ends of the threaded bolts 300 and avoid inadvertent touching of the threaded bolts 300. As such, the threaded bolts 300 are touch safe. Additionally, the housing 230 includes the blocking walls 248 around the contact channels 246 and surrounding the power contact 270. The blocking walls 248 are positioned relative to the power contact 270 to make the power contact 270 touch safe. For example, the blocking walls 248 extend along the side walls 290, 292 of the power contact 270 to block or prevent inadvertent touching of the side walls 290, 292. The blocking walls 248 may be located in the gap 284 and outside of the gap 284. Slots 286 are provided between corresponding blocking walls 248. The slots 286 are open at the bottom 236 of the housing 230 to provide access to the side walls 290, 292. However, the widths of the slots 286 is relatively narrow to prevent a persons finger or tool from entering the slots 286 to inadvertently touch the side walls 290, 292. As such, the housing 230 is touch safe at the mating end.

In an exemplary embodiment, the housing shield 225 extends into the lower opening 256 to interface with the second harness connector 400 when the first harness connector 200 is plugged onto the second harness connector 400. For example, the housing shield 225 may include shield fingers 227 extending into the lower opening 256. The shield fingers 227 are configured to be coupled to a corresponding housing shield of the second harness connector 400 to electrically common the first harness connector 200 to the second harness connector 400.

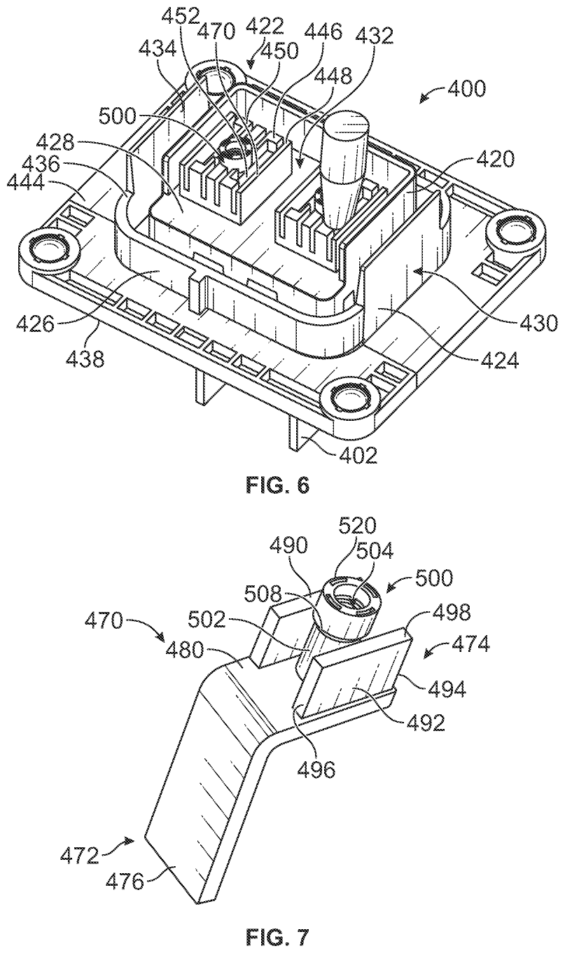

FIG. 6 is a top perspective view of the second harness connector 400 in accordance with an exemplary embodiment. The second harness connector 400 includes a power conductor 402, a housing 430, one or more power contacts 470, and one or more threaded connectors 500. In the illustrated embodiment, the second harness connector 400 includes a pair of the power contacts 470 and corresponding threaded connectors 500 held within the same housing 430. Greater or fewer power contacts 470 and threaded connectors 500 may be provided in alternative embodiments.

The housing 430 receives the power contacts 470 and the threaded connectors 500. The housing 430 may receive the power conductor(s) 402. However, in alternative embodiments, the power contacts 470 extend from the housing 430 to interface with the power conductor(s) 402. The housing 430 is configured to be mated with the first harness connector 200 (shown in FIG. 2). The threaded connectors 500 are used to mechanically connect the second harness connector 400 to the first harness connector 200. For example, the threaded connectors 500 may be threadably coupled to the threaded bolts 300 (shown in FIG. 2). The power contacts 470 are used to electrically connect the power conductors 402 to the first harness connector 200.

In an exemplary embodiment, the housing 430 is configured to be coupled to the second component 106 (shown in FIG. 1). For example, the housing 430 may be fixed directly to the second component 106 such as to supply power to the second component 106. In various embodiments, the second component 106 may be a battery and the housing 430 is coupled directly to the battery box or battery distribution unit. In other embodiments, the second component 106 is a motor or inverter and the housing 430 is coupled directly to the motor/inverter or to a chassis of the vehicle at the motor/inverter. The second component 106 may be other types of components in alternative embodiments.

In an exemplary embodiment, each power conductor 402 is a terminal of the second component 106 used to power the second component 106. In other various embodiments, the power conductor 402 is a busbar, such as a busbar coupled to the second component 106 to power the second component 106. In other various embodiments, the power conductor 402 is a power cable, such as a power cable used to power the second component 106. The power conductor 402 may be a metal plate or bar. The power conductor 402 may be a stamped and formed part in alternative embodiments. The power conductor 402 may be a braided metal tape or stranded wire or cable in other alternative embodiments.

In an exemplary embodiment, the second harness connector 400 includes a housing shield 420. The housing shield 420 is configured to be electrically connected to the second component 106. The housing shield 420 includes a mating end 422 at the top configured to be mated with the housing shield 225 of the first harness connector 200. The housing shield 420 includes walls 424 surrounding the power contacts 470 to provide shielding for the power contacts 470.

The housing 430 is manufactured from a dielectric material, such as a plastic material. Optionally, the housing 430 may be an injection molded part. In various embodiments, the housing 430 is a multi-piece housing. For example, the housing 430 may include an outer shell 426 and a housing insert 428 received in the outer shell 426. The housing shield 420 is located in the housing 430, such as between the outer shell 426 and the housing insert 428. The housing shield 420 may be held by the outer shell 426 and/or the housing insert 428. The various components of the housing 430 described herein may be part of the outer shell 426 and/or the housing insert 428. In other various embodiments, the housing 430 may be clamshell type housing having an upper housing and a lower housing.

The housing 430 includes shroud walls 434 forming a chamber 432 that receives the power contacts 470 and the threaded connectors 500. The chamber 432 may receive the power conductors 402. The housing shield 420 provides shielding within the chamber 432. In an exemplary embodiment, the housing 430 includes a top 436 and a bottom 438. The housing 430 includes a mounting flange 444 at the bottom 438 configured to be mounted to the second component 106. For example, the mounting flange 444 may be secured to the second component 106 using fasteners, such as in the four corners of the mounting flange 444. The shroud walls 434 extend from the mounting flange 444 to the top 436. The shroud walls 434 have distal ends at the top 436 configured to be plugged into the housing 230 of the first harness connector 200, such as into the groove 258 to interface with the mating seal 360.

In an exemplary embodiment, the housing 430 includes one or more contact channels 446 in the chamber 432 that receive the corresponding power contacts 470. The contact channels 446 receive the power contacts 470 through the bottom 438. The housing 430 includes walls defining the contact channels 446. For example, the walls form slots defining the contact channels 446. In an exemplary embodiment, the walls define blocking walls 448 at the top 436. The blocking walls 248 surround the contact channels 446 and surround the power contact 470. The blocking walls 448 are positioned relative to the power contacts 470 to make the power contacts 470 touch safe. For example, the blocking walls 448 extend along the power contacts 470 to block or prevent inadvertent touching of the power contacts 470.

In an exemplary embodiment, the housing 430 includes a hub 450 having a bore 452 passing through the hub 450 that receives the corresponding threaded connector 500. The bore 452 passes through the housing 430, such as along a vertical axis between the top 436 and the bottom 438. In an exemplary embodiment, the power contact 470 is positioned in the housing 430 aligned with the bore 452, such as along the vertical axis, to receive the threaded connector 500 and/or the threaded bolt 300.

With additional reference to FIG. 7, which is a perspective view of the power contact 470 in accordance with an exemplary embodiment, the power contact 470 is a metal conductor, such as an aluminum or copper conductor. The power contact 470 may be an extruded metal contact in various embodiments. Alternatively, the power contact 470 may be hot forged or stamped and formed. The power contact 470 may be plated or coated in various embodiments.

The power contact 470 extends between a terminating end 472 and a mating end 474. The terminating end 472 is configured to be terminated to the power conductor 402. The mating end 474 is configured to be mated with the corresponding power contact 270 of the first harness connector 200. The power contact 470 includes a weld pad 476 at the terminating end 472. The power conductor 402 is welded to the weld pad 476 at the terminating end 472. Other types of terminations may be used in alternative embodiments, such as a crimp barrel.

The power contact 470 includes a base plate 480 at the mating end 474. The base plate 480 may be planar. In various embodiments, the base plate 480 may be oriented horizontally. The base plate 480 includes an opening (not shown) therethrough, which may be approximately centered between the front and the rear and/or between the opposite sides of the base plate 480.

In an exemplary embodiment, the power contact 470 includes side walls 490, 492 extending from the base plate 480. The side walls 490, 492 are located on opposite sides of a gap 484. The gap 484 is aligned with the opening, such as to receive the threaded connector 500. Each side wall 490, 492 extends between a front 494 and a rear 496. The gap 484 may be open at the front 494 and/or the rear 496. Each side wall 490, 492 extends to an outer edge 498 opposite the base plate 480. The gap 484 is open between the outer edges 498. The outer edges 498 form mating interfaces for mating engagement with the power contact 270 of the first harness connector 200. For example, the outer edges 498 interface with the outer edges 298 of the power contact 270. The side walls 490, 492 have lengths (between the front 494 and the rear 496) and widths (side-to-side), which define a surface area at the mating interface. The surface area may control the amount of power or current carrying capacity for the power contact 470. The surface area may be increased by increasing the lengths or widths of the side walls 490, 492.

In an exemplary embodiment, the side walls 490, 492 extend parallel to each other on opposite sides of the gap 484. The side walls 490, 492 may be oriented perpendicular to the base plate 480. In various embodiments, the base plate 480 and the side walls 490, 492 are U-shaped surrounding the gap 484. Optionally, the base plate 480 may be orientated horizontally and the side walls 490, 492 may be oriented vertically.

In an exemplary embodiment, the threaded connector 500 is a threaded insert. The threaded connector 500 includes a base 502 at a bottom of the threaded connector 500. The base 502 is configured to be coupled to the power contact 470, such as to the base plate 480. The threaded connector 500 includes a threaded tube 504. The threaded tube 504 includes internal threads inside the hollow bore of the threaded tube 504. The threaded tube 504 extends to a distal end 508. In an exemplary embodiment, the threaded connector 500 is touch safe. For example, the threaded connector 500 includes an insulating cap 520 at the distal end 508 of the threaded tube 504. The insulating cap 520 may be overmolded onto the threaded tube 504. Alternatively, the insulating cap 520 may be pre-formed and snap-fit, press-fit, adhered, or otherwise secured to the distal end 508 of the threaded tube 504. The insulating cap 520 covers the threaded tube 504 to prevent touching of the metal or conductive portion of the threaded connector 500.

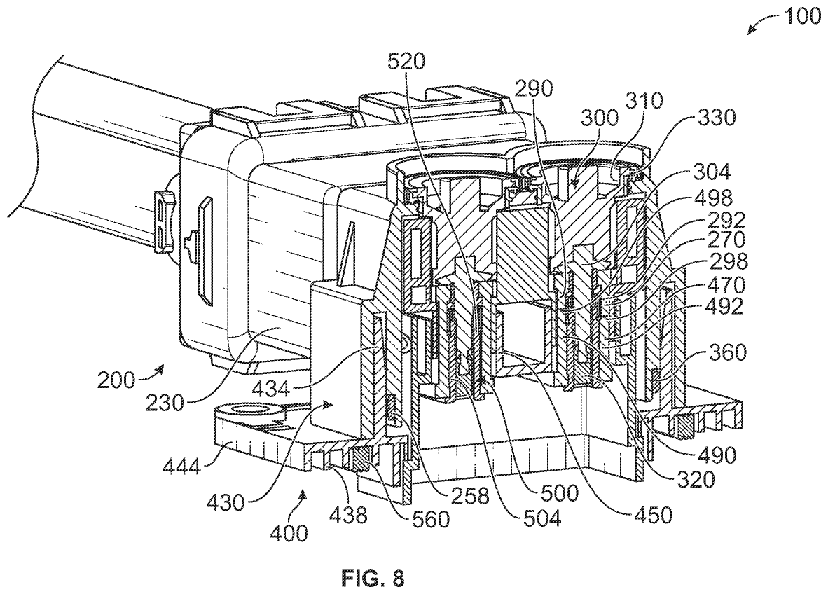

FIG. 8 is a cross sectional view of the power system 100 showing the first harness connector 200 mated with the second harness connector 400. The first and second harness connectors 200, 400 are mated in a mating direction along a mating axis. The mating axis may be a vertical axis.

During mating, the housings 230, 430 are aligned with each other. The shroud walls 434 are aligned with the groove 258 and plugged into the groove 258 when the first harness connector 200 is mated with the second harness connector 400. The shroud walls 434 are used to align the threaded connectors 300 (for example, threaded bolts) with the threaded connectors 500 (for example, threaded inserts). During mating, the threaded bolts 300 are plugged into the threaded connector 500. For example, the insulating cap 320 at the end of the threaded bolt 300 is plugged into the hollow bore of the threaded tube 504, such as through the insulating cap 520. When the threaded shaft 304 interfaces with the threaded tube 504, the threaded bolt 300 is rotated to tighten the threaded bolt 300 to the threaded connector 500.

When mated, the power system 100 is touch safe. The insulating cover 310 covers the top of the threaded bolt 300 such that no metal or conductive portion of the threaded bolt 300 may be touched from the exterior of the first harness connector 200. The housings 230, 430 cover or enclose the power contacts 270, 470 such that no metal or conductive portion of the power contacts 270, 470 may be touched from the exterior of the harness connectors 200, 400. In an exemplary embodiment, the portion of the threaded bolt 300 that is exposed at the exterior of the housing 230 is the insulating cap 320. No metal or conductive portion of the threaded bolt 300 is exposed. As such, the first harness connector 200 is touch safe in the unmated state. Similarly, the end of the threaded connector 500 may extend from the exterior of the housing 430, such as beyond the top of the hub 450. The portion of the threaded connector 500 that is exposed at the exterior of the housing 430 is the insulating cap 520. No metal or conductive portion of the threaded connector 500 is exposed. As such, the second harness connector 400 is touch safe in the unmated state. The insulating cover 310 covers the top end of the threaded bolt 300 making the first harness connector 200 touch safe.

During mating, the upper portion of the housing 430 of the second harness connector 400 is plugged into the lower portion of the housing 230 of the first harness connector 200. When mated, the power system 100 is sealed from the external environment. In the illustrated embodiment, the first harness connector 200 carries the mating seal 360 to interface with the shroud walls 434 of the second harness connector 400 during mating. As such, a sealed interface is provided between the first and second harness connectors 200, 400. In an exemplary embodiment, other openings in the housings 230, 430 are sealed, such as by the bolt seals 330. In an exemplary embodiment, a component seal 560 is provided at the bottom 438 of the housing 430. The component seal 560 is configured to be sealed to the second component 106. In the illustrated embodiment, the component seal 560 extends along the mounting flange 444.

The threaded bolt 300 and the threaded connector 500 are used to mechanically connect the first harness connector 200 to the second harness connector 400. For example, the threaded shaft 304 of the threaded bolt 300 is received in the bore of the threaded tube 504 of the threaded connector 500. The threaded bolt 300 is rotated to tighten the threaded shaft 304 in the threaded tube 504. As the threaded bolt 300 is tightened, the first harness connector 200 is electrically connected to the second harness connector 400. For example, the threaded connection between the threaded bolt 300 and the threaded connector 500 presses the power contact 270 into electrical connection with the power contact 470. The side walls 290, 292 of the power contact 270 are mated with the side walls 490, 492 of the power contact 470. For example, the outer edges 298 engage the outer edges 498 to electrically connect the power contact 270 to the corresponding power contact 470. The threaded connectors 300, 500 maintain electrical connection between the power contacts 270, 470. As such, an efficient power transmission path is created between the first and second harness connectors 200, 400. A compact, robust, sealed, vibration resistant, and touch safe electrical connection is made between the first and second harness connectors 200, 400.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. A power harness comprising:
a housing having a chamber extending between a terminating end and a mating end configured to be mated with a mating harness connector of the power harness, the housing including a hub at the mating end with a bore passing through the housing;
a power conductor extending from the chamber at the terminating end;
a power contact received in the chamber, the power contact having a terminating end terminated to the power conductor and a mating end aligned with the bore at the mating end of the housing, the power contact including a base plate at the mating end and side walls extending from the base plate on opposite sides of a gap, the side walls having outer edges opposite the base plate, the outer edges forming mating interfaces for mating engagement with a mating power contact of the mating harness connector, the base plate having an opening aligned with the gap; and
a threaded connector received in the hub and passing through the bore, the threaded connector aligned with the opening and located in the gap between the side walls, the threaded connector configured to be threadably coupled to a mating threaded connector of the mating harness connector.

2. The power harness of claim 1, wherein the base plate and the side walls are U-shaped.

3. The power harness of claim 1, wherein the side walls extend parallel to each other.

4. The power harness of claim 1, wherein each side wall extends between a front and a rear, the gap being open at the front.

5. The power harness of claim 1, wherein the bore extends along a bore axis, the base plate being oriented perpendicular to the bore axis, the side walls being oriented parallel to the bore axis.

6. The power harness of claim 1, wherein the housing includes a contact channel, the power contact being loaded into the contact channel.

7. The power harness of claim 1, wherein the housing includes blocking walls surrounding the power contact, the blocking walls being positioned relative to the power contact to make the power contact touch safe.

8. The power harness of claim 1, further comprising a housing seal at the mating end of the housing configured to interface with the mating harness connector to create a sealed interface with the mating harness connector.

9. The power harness of claim 1, wherein the threaded connector includes a threaded connector seal configured to seal between the threaded connector and the housing.

10. The power harness of claim 1, wherein the threaded connector includes an insulating cover and an exterior of the housing, the insulating cover positioned to make the threaded connector touch safe.

11. The power harness of claim 1, further comprising a housing shield in the chamber, the housing shield providing shielding for the power contact, the housing shield configured to engage the mating harness connector to electrically common the housing shield and the mating harness connector.

12. A power harness comprising:
a housing having a chamber extending between a cable end and a mating end configured to be mated with a mating harness connector of the power harness, the housing including a housing insert and an outer shell holding the housing insert, the housing insert including a hub at the mating end with a bore passing through the hub, the housing insert including a contact channel;
a housing shield in the chamber, the housing shield having a shield cable end and a shield mating end configured to be mated to a mating shield of the mating harness connector;
a housing seal at the mating end of the housing, the housing seal configured to be sealed to the mating harness connector;
a power cable extending into the chamber at the cable end, the power cable including a power conductor, an insulator surrounding the power conductor, and a cable shield surrounding the insulator, the cable shield being electrically connected to the shield cable end of the housing shield, the power cable including a cable seal configured to be sealed between the power cable and the housing to seal the terminating end of the housing;
a power contact received in the chamber, the power contact having a terminating end terminated to the power conductor of the power cable and a mating end aligned with the bore at the mating end of the housing, the power contact including a base plate at the mating end and side walls extending from the base plate on opposite sides of a gap, the side walls having outer edges opposite the base plate, the outer edges forming mating interfaces for mating engagement with a mating power contact of the mating harness connector, the base plate having an opening aligned with the gap; and
a threaded bolt received in the hub and passing through the bore, the threaded bolt aligned with the opening and located in the gap between the side walls, the threaded bolt including an insulating cover covering a head and an insulating cap at a distal end of a threaded shaft, the threaded shaft configured to be threadably coupled to a mating threaded connector of the mating harness connector, the threaded bolt including a bolt seal sealed between the threaded bolt and the housing.

13. The power harness of claim 12, wherein the base plate and the side walls are U-shaped.

14. The power harness of claim 12, wherein the side walls extend parallel to each other.

15. The power harness of claim 12, wherein each side wall extends between a front and a rear, the gap being open at the front.

16. The power harness of claim 12, wherein the housing includes blocking walls surrounding the power contact, the blocking walls being positioned relative to the power contact to make the power contact touch safe.

17. A power harness comprising:
a first harness connector including a first housing having a first hub with a first bore passing through the first housing, the first harness connector including a first power conductor, the first harness connector including a first seal sealed to the first housing, the first harness connector including a threaded bolt received in the first hub and passing through the first bore, the threaded bolt including an insulating cover covering a head and an insulating cap at a distal end of a threaded shaft, the first harness connector including a bolt seal sealed between the threaded bolt and the first housing, the first harness connector including a first power contact received in the first hub, the first power contact having a terminating end terminated to the first power conductor and a mating end aligned with the first bore, the first power contact including a first base plate and first side walls extending from the first base plate on opposite sides of a first gap, the first gap receiving the threaded bolt, the first side walls having outer edges opposite the first base plate;
a second harness connector coupled to the first harness connector, the second harness connector including a second housing having a second hub with a second bore passing through the second housing, the second harness connector including a second power conductor, the second harness connector including a second cable seal sealed to the second housing, the second harness connector including a socket insert received in the second hub and passing through the second bore, the socket insert including a threaded bore threadably coupled to the threaded bolt of the first harness connector, the socket insert including an insulating cap at a distal end of socket insert, the second harness connector including a second power contact having a terminating end terminated to the second power conductor and a mating end aligned with the second bore, the second power contact including a second base plate and second side walls extending from the second base plate on opposite sides of a second gap, the second gap receiving the socket insert, the second side walls having outer edges opposite the second base plate configured to interface with the outer edges of the first side walls to electrically connect the second power contact to the first power contact; and
a mating seal sealed between the first housing and the second housing at a mating interface between the first and second harness connectors.

18. The power harness of claim 17, wherein the first power conductor is a power cable terminated to the terminating end of the first power contact, the power cable extending from the first connector housing, the second connector housing being mounted to an electrical device, the second power contact terminated to the electrical device to transfer power between the first power contact and the electrical device.

19. The power harness of claim 17, wherein the first and second harness connectors are both touch-proof both before and after coupling.

20. The power harness of claim 17, wherein the first and second harness connectors are completely sealed when mated.
